(19) United States
(12) Patent Application Publication
(10) Pub. No.: US 2006/0197913 A1
(43) Pub. Date: Sep. 7, 2006

(54) Portable image displaying apparatus

(76) Inventors: William Pan, Taipei (TW); Ssu-Kuang Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/417,175

(22) Filed: May 4, 2006

Related U.S. Application Data
(63) Continuation-in-part of application No. 10/813,089, filed on Mar. 31, 2004, now abandoned.

(51) Int. Cl. G03B 17/02

(52) U.S. Cl. 352/242

(57) ABSTRACT

A portable image displaying apparatus for medical applications for accessing, selecting, and viewing at least one DICOM image includes a casing and a LCOS micro display device arranged within the casing. The casing is ergonomically shaped for ease handling by user's hand and is provided with a plurality of buttons thereon for user's operation. The portable image displaying apparatus has a built-in memory or a card reader to access an external memory. Therefore, the portable image displaying apparatus can download image stored in a computer by wired or wireless way.

### CROSS REFERENCE TO RELATED APPLICATION

This application is a continuation-in-part of U.S. application Ser. No. 10/813,089, filed on 31 Mar. 2004 and entitled “PORTABLE IMAGE VIEWING APPARATUS”, now pending.

### BACKGROUND OF THE INVENTION

1. Field of the Invention

The present invention relates to a portable image displaying apparatus, especially to a portable image displaying apparatus with a LCOS micro display device for medical applications for accessing, selecting and viewing at least one DICOM (Digital Image Communication in Medicine) image that can be held by single hand of user and can be easily operated through buttons provided on the casing thereof.

2. Description of the Related Art

Medical images or photos such as x-ray photos or CT (computed tomography) images are essential to a doctor for the diagnosis of patient. Delivery of an x-ray photo to a patient's room is a long-existing problem that is time consuming and troublesome.

As the rapid progress of digitalized image, the medical image or photo such as x-ray photos or CT (computed tomography) images can be digitalized and stored in a notebook computer. However, the notebook computer is heavy and bulky to carry and its battery cannot sustain for a long time.

### SUMMARY OF THE INVENTION

It is an object of the present invention to provide a portable image displaying apparatus, which comprises a casing and a LCOS micro display device arranged within the casing. It is another object of the present invention to provide a portable image displaying apparatus, which comprises a viewing window and an adjusting part placed outside the viewing window to adjust focal length of the viewing window for observing the LCOS micro display.

It is another object of the present invention to provide a portable image displaying apparatus, which comprises a built-in memory or a card reader to access an external memory. Therefore, the portable image displaying apparatus can download image stored in a computer.

It is yet an object of the present invention to provide a portable image displaying apparatus, which comprises a microprocessor having a GUI (graphical user interface) program coupled to the at least one circuit board for selecting a desired DICOM image or adjusting the desired DICOM image size.

### BRIEF DESCRIPTION OF THE DRAWINGS

The various objectives and advantages of the present invention will be more readily understood from the following detailed description when read in conjunction with the appended drawing, in which:

FIG. 1 shows a schematic view of the portable displaying apparatus according to a preferred embodiment of the present invention;

FIG. 2 shows a cross sectional view of the portable displaying apparatus according to a preferred embodiment of the present invention;

FIG. 3 shows an exploded view of the portable displaying apparatus according to a preferred embodiment of the present invention;

FIG. 4 shows a schematic diagram of the portable image displaying apparatus using LCOS display device;

FIG. 5 shows a block diagram of the LCOS micro display used in the portable displaying apparatus according to a preferred embodiment of the present invention; and

FIG. 6 depicts the application of the portable displaying apparatus according to the present invention.

### DETAILED DESCRIPTION OF PREFERRED EMBODIMENTS

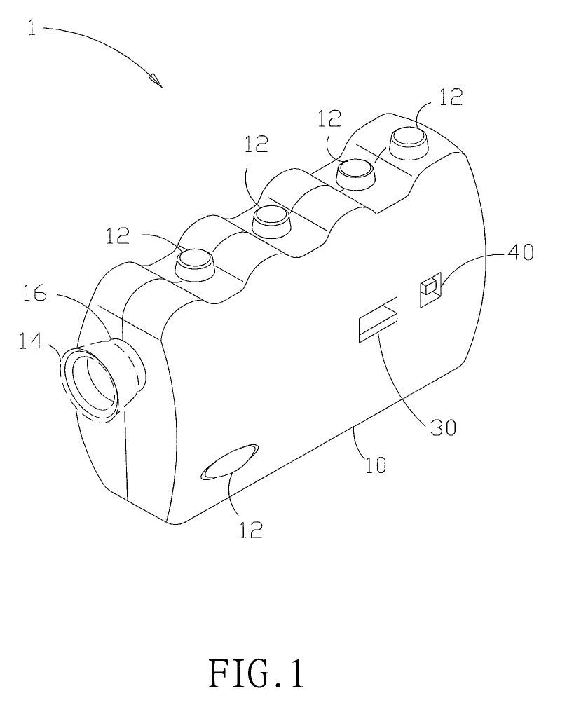

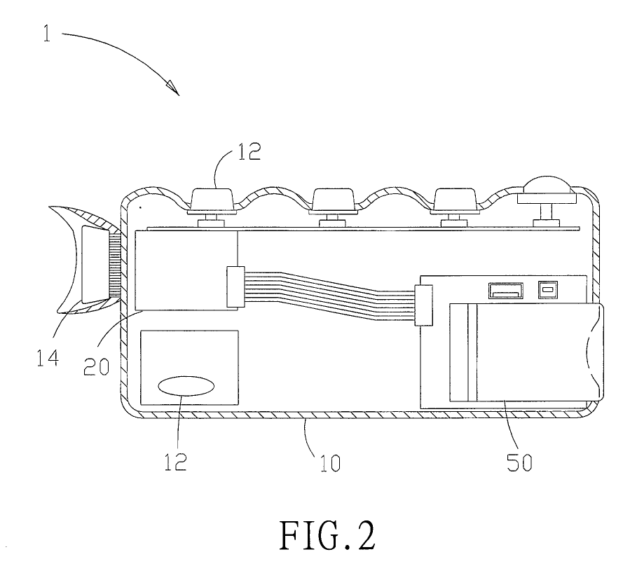

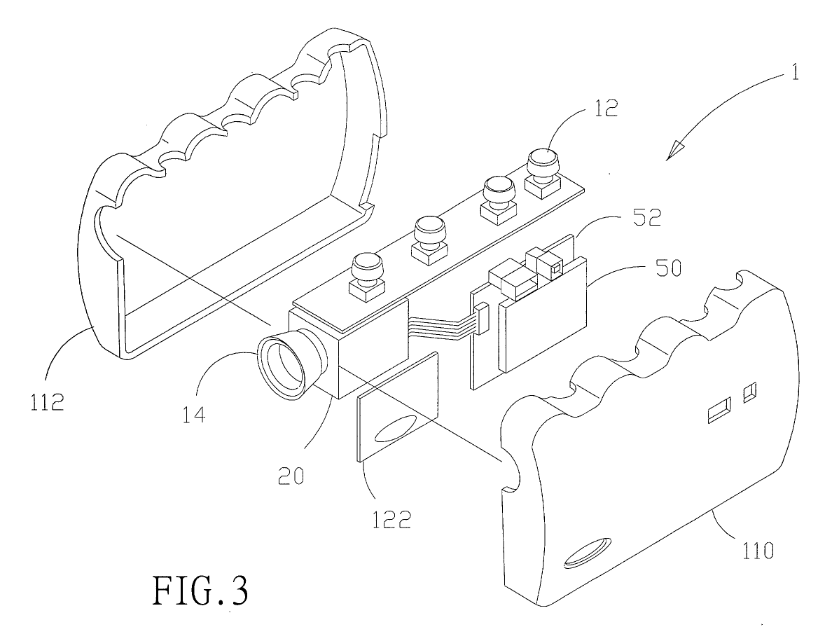

With reference now to FIGS. 1 to 3, those figures show a schematic view, a cross sectional view and an exploded view of the portable displaying apparatus according to a preferred embodiment of the present invention. In this preferred embodiment, the portable displaying apparatus is implemented with LCOS (liquid crystal on silicon) as a micro display, which may be viewed directly or with some auxiliary device such as a microscope.

The portable image displaying apparatus 1 is composed of a casing 10, a LCOS micro display 20 and a plurality of buttons 12. The casing 10 is composed of a first shell 110 and a second shell 112 and is ergonomically shaped for ease handling by user's hand. Moreover, the casing 10 is defined a receiving space (not labeled) therein. The buttons 12 are arranged on such places of the casing 10 that user can easily operate them for executing certain functions, for example, viewing next photograph or fast viewing. The buttons 12 are electrically connected with a first circuit board 122 and the first circuit board 122 is electrically connected with the LCOS micro display 20. The LCOS micro display 20 is place into the receiving space in casing 10.

In addition, a viewing window 14 is provided on the casing 10. At least one transparent glass or lenses is provided inside the viewing window 14, and an adjusting part 16 is placed outside the viewing window 14 to adjust a focal length of the viewing window 14 for observing the LCOS micro display 20. The LCOS micro display 20 can be observed through the viewing window 14 in ocellar way. The digitalization of X-ray plate is an already know art and is not stated in detail here for simplicity. The portable image displaying apparatus 1 according to the present invention further comprises a built-in memory unit 50 to store digitalized X-ray medial images. Moreover, the portable displaying apparatus may further comprises a microscope (not shown) for facilitating the observation of the LCOS micro display 20.

The portable image displaying apparatus 1 further comprises a memory card reader (not shown) electrically connected with the first circuit board 122. The memory card reader can read the stored image data in a memory card, therefore the portable image displaying apparatus 1 can easily access images stored in memory card.

The portable image displaying apparatus 1 further comprises at least one computer connecting port, for example, a USB connecting port 30 or an IEEE1394 connecting port 40. The portable image displaying apparatus 1 can be wired to a computer for data exchange. Alternatively, the portable image displaying apparatus 1 can also include a wireless data unit such as a Bluetooth unit to receive medical image data in a wireless way. The invention is not restricted to specific kinds of data access methods.

Furthermore, the memory unit 50 is also electrically connected with a second circuit board 52, and the second circuit board is connected with the LCOS micro display 20. The LCOS micro display 20 is not restricted to be specific display devices stated in this specification, for example, LED or LCOS. LCOS is a display device with high resolution, so it can display 3D image. Next, it is low cost and also conserves power. For this reason, LCOS is more fit for the portable image displaying apparatus 1.

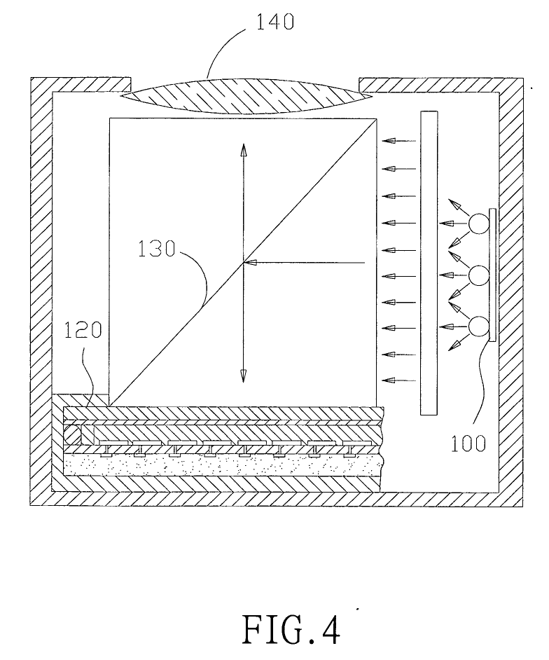

Please refer to FIG. 4, which shows a schematic diagram of the portable image displaying apparatus 1 using LCOS display device. The LCOS display device is a reflective type micro LCD device. The LCOS display device is composed of a CMOS substrate having transistors grown on a silicon wafer, panel formed by semiconductor technology (it's also called CMOS LCD), and an Al-plated mirror. The CMOS substrate is then assembled with a glass substrate having transparent electrode and liquid crystal is injected into the LCOS display device. A light emitted from a light source 100 first passes through a lens 111 and is then reflected to an LCOS chip 120 by a reflecting mirror 130. The LCOS chip 120 is provided for producing the image according to the light from the reflecting mirror 130. Next, the image from the LCOS chip 120 passes through a convex lens 140 for being viewed by the user.

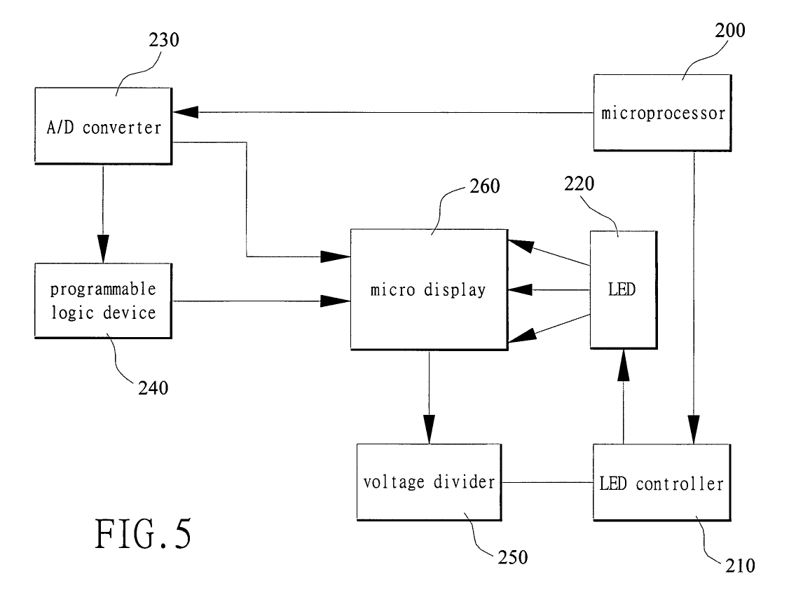

FIG. 5 shows a block diagram of the LCOS micro display used in the portable displaying apparatus according to a preferred embodiment of the present invention. A microprocessor 200 has a GUI (graphical user interface) program coupled to the second circuit board 52 for selecting a desired DICOM image or adjusting the desired DICOM image size. The microprocessor 200 is connected with an A/D converter 230 to provide power for a programmable logic device 240 and a LCOS micro display 260. The microprocessor 200 can control an LED 220 and a voltage divider 250 by controlling an LED controller 210. However, the A/D converter 230 can be replaced by a DC power supply to enhance portability.

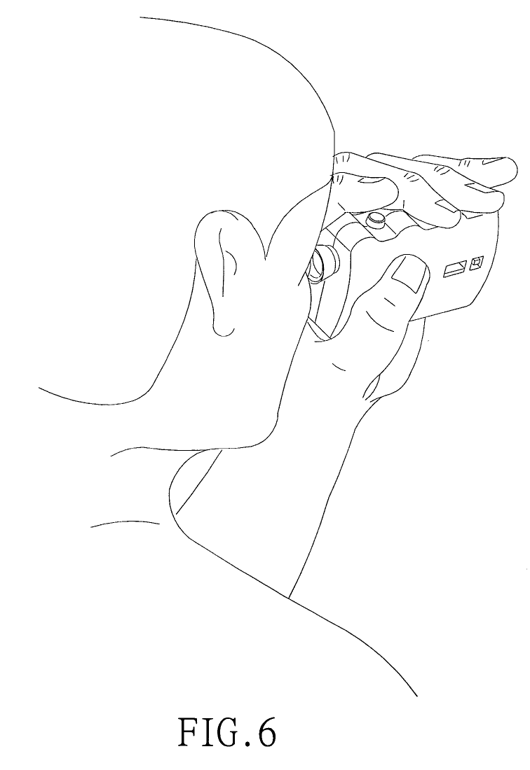

FIG. 6 depicts the application of the portable displaying apparatus according to the present invention.

The present invention is intended to provide an easily carrying and ergonomically portable image displaying apparatus. The apparatus can be operated with one hand. Functional buttons on it are all set on the positions that fingers can hold, for example, next pager or rapidly play etc. Meanwhile, the display apparatus has built-in memory device or can be equipped with card reader to store image data. Moreover, we can store and load image data in computers by connecting them in wired or wireless way. The invention also can be used for multi-connecting in teaching or watching transferring images. The invention display images by a LCOS micro display and the LCOS micro display is not restricted to certain kind of technique of LCOS micro display; it depends on the resolution that users need. LCD or high resolution LCOS are both usable.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A portable image displaying apparatus for medical applications for accessing, selecting and viewing at least one DICOM (Digital Image Communication in Medicine) image, the portable image displaying apparatus comprising:
a casing defining a receiving space therein, the casing having an upper portion with an undulating contour to define finger receiving positions and a plurality of buttons provided at the finger receiving positions for operation and support of the apparatus by one hand of a user, at least one viewing window being provided on the casing;
a computer connecting port on the casing being connected to a computer through a connection wire, the computer connecting port is a USB port or an IEEE 1394 port;
a transparent glass inside the viewing window, the transparent glass is a lens;
a microscope inside the viewing window for viewing the at least one LCOS micro display;
an adjusting part placed outside the viewing window to adjust a focal length of the viewing window for observing the LCOS micro display, the buttons being set at position to be contacted by a user's fingers for functions including next page and fast viewing;
at least one LCOS micro display arranged in the receiving space and aligned with the viewing window, the LCOS micro display including (a) a light source, (b) a lens through which light emitted from the light source passes, (c) a reflecting mirror for reflecting the emitted light passing through the lens, (d) a LCOS chip for producing the at least one DICOM image using the light from the reflecting mirror, and (e) a convex lens through which the at least one DICOM image from the LCOS chip passes to be viewed by a user;
at least one circuit board arranged in the receiving space and electrically connected to the plurality of buttons and the at least one LCOS micro display for driving the at least one LCOS micro display to display the at least one DICOM image;
a Bluetooth unit connected to the at least one circuit board for communicating with a computer with another wireless data unit;
a card reader electrically connected to the at least one circuit board, the portable image displaying apparatus accessing a memory card through the card reader;
a microprocessor having a GUI (graphical user interface) program coupled to the at least one circuit board for selecting a desired DICOM image or adjusting the desired DICOM image size; and,
a memory unit coupled to the at least one circuit board for accessing DICOM image data.
